(19) United States
(12) Patent Application Publication
(10) Pub. No.: US 2023/0371741 A1
(43) Pub. Date: Nov. 23, 2023

(54) Pizza Cooking Stone Device

(71) Applicant: Shannon Dinkins, Winter Park, FL (US)

(72) Inventor: Shannon Dinkins, Winter Park, FL (US)

(21) Appl. No.: 18/319,012

(22) Filed: May 17, 2023

Related U.S. Application Data
(60) Provisional application No. 63/342,666, filed on May 17, 2022.

(51) Int. Cl. A47J 37/01; G01K 11/12; A47J 36/02; A47J 36/04

(52) U.S. Cl. CPC A47J 37/01; G01K 11/12; A47J 36/025; A47J 36/04; A47J 2202/00

(57) ABSTRACT

The present invention relates to a pizza cooking stone device. The device is comprised of a body, further comprised of at least one handle and a bottom surface having at least one rotating disc or at least one foot. The handle allows the device to be easily carried to and from an oven. Further, the rotating disc allows the body to rotate while being used to serve pizza. The foot prevents the bottom surface of the body from touching the surface that the device is placed onto to avoid damaging the surface due to the heat of the body.

### CROSS-REFERENCE TO RELATED APPLICATION

The present application claims priority to, and the benefit of, U.S. Provisional Application No. 63/342,666, which was filed on May 17, 2022, and is incorporated herein by reference in its entirety.

### FIELD OF THE INVENTION

The present invention relates generally to the field of pizza stones. More specifically, the present invention relates to a pizza cooking stone device comprised of a body, further comprised of at least one handle and a bottom surface having at least one rotating disc or at least one foot. The handle allows the device to be easily carried to and from an oven. Further, the rotating disc allows the body to rotate while being used to serve pizza. The foot prevents the bottom surface of the body from touching the surface that the device is placed onto to avoid damaging the surface due to the heat of the body. Accordingly, the present disclosure makes specific reference thereto. Nonetheless, it is to be appreciated that aspects of the present invention are also equally applicable to other like applications, devices, and methods of manufacture.

### BACKGROUND

A pizza stone is a flat slab of material that is placed directly on an oven rack or inside a pizza oven. Pizza stones are designed to transfer heat to the bottom of a pizza for slower, more even baking. A pizza stone absorbs the heat produced within an oven and transmits said heat to the raw pizza dough placed on top of it. As a result, many individuals enjoy cooking pizzas with pizza stones. However, pizza stones typically only include the stone itself. Therefore, a pizza peel or other device, such as an oven mitt, must be used to remove the pizza stone from a pizza oven after cooking has been completed. This is undesirable, as many users may not possess a pizza peel or oven mitt. In addition, pizza stones may damage surfaces by warping or damaging the surface with their extreme heat.

Therefore, there exists a long-felt need in the art for an improved pizza stone. There also exists a long-felt need in the art for a pizza cooking stone device that can be easily moved from a cooking oven to another location without the need for external tools. In addition, there exists a long-felt need in the art for a pizza cooking stone device that does not damage a surface when placed on said surface while hot. Further, there exists a long-felt need in the art for a pizza cooking stone device that has features that improve the serving functionality of the device.

The subject matter disclosed and claimed herein, in one embodiment thereof, comprises a pizza cooking stone device. In the preferred embodiment, the device is comprised of a body, further comprised of at least one handle and a bottom surface having at least one rotating disc or at least one foot. The handle allows the device to be easily carried. The rotating disc allows the body to rotate while being used to serve pizza. The foot prevents the bottom surface of the body from touching the surface that the device is placed onto to avoid damaging the surface due to the heat of the body.

In this manner, the pizza cooking stone device of the present invention accomplishes all of the foregoing objectives and provides an improved pizza stone. The device can be easily moved from a cooking oven to another location using the handle. In addition, the feet ensure the device does not damage a surface when placed on said surface while hot. Further, the rotating disc improves the serving functionality of the device.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pizza cooking stone device. In the preferred embodiment, the device is comprised of a body, further comprised of at least one handle and a bottom surface having at least one rotating disc and at least one foot. The device is primarily comprised of a body with a top surface having at least one indicia, a bottom surface having at least one foot, and a handle further comprised of at least one grip. The body of the device is preferably made from a ceramic, cordierite, clay, metal, cast iron, stone, or a composite material that conducts heat. In one embodiment, the top surface of the body is comprised of at least one indicia that may only be visible when the internal temperature of the body exceeds a specific temperature.

The bottom surface of the body may further be comprised of at least one foot that is preferably manufactured from a material with low heat conducting properties and a high melting point. The foot is preferably flat such that it contacts any surface the device is placed on such that the bottom surface of the device does not contact the surface which the device is placed on. Therefore, the surface cannot be burned, scorched, or warped by the hot bottom surface if the device is taken directly out of a pizza oven and placed onto a surface to cool or serve pizza. In one embodiment, the bottom surface has a single foot that attaches to the bottom surface via at least one rotating disc that allows the body to rotate while serving pizza while the foot remains stationary.

In one embodiment, the body is further comprised of at least one handle that can attach to the top surface, the bottom surface, or side surface in a fixedly attached manner or via at least one hinge that allows the handle to fold when not in use. The hinge may also be locked/unlocked using at least one button located on the handle.

The handle is preferably made from a durable metal material and is further comprised of at least one grip that is preferably made from a rubber material with low heat conducting properties to allow a user to safely grab the handle when hot. In one embodiment, the grip may be textured to provide sufficient grip. In one embodiment, the handle is comprised of an opening that allows the handle (and therefore the device) to be hung or secured to another object, item, or location.

Accordingly, the pizza cooking stone device of the present invention is particularly advantageous as it provides an improved pizza stone that can be easily moved from a cooking oven to another location using the handle. Further, the feet ensure the device does not damage a surface when placed on said surface while hot, and the rotating disc improves the serving functionality of the device. In this manner, the pizza cooking stone device overcomes the limitations of existing pizza stones known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a pizza cooking stone device of the present invention in accordance with the disclosed architecture;

FIG. 2 illustrates a side view of one potential embodiment of a pizza cooking stone device of the present invention in accordance with the disclosed architecture;

FIG. 3 illustrates a perspective view of one potential embodiment of a pizza cooking stone device of the present invention while inside an oven in accordance with the disclosed architecture; and

FIG. 4 illustrates a flowchart of one potential method of using one potential embodiment of a pizza cooking stone device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved pizza stone. There also exists a long-felt need in the art for a pizza cooking stone device that can be easily moved from a cooking oven to another location without the need for external tools. In addition, there exists a long-felt need in the art for a pizza cooking stone device that does not damage a surface when placed on said surface while hot. Further, there exists a long-felt need in the art for a pizza cooking stone device that has features that improve the serving functionality of the device.

The present invention, in one exemplary embodiment, is comprised of a pizza cooking stone device preferably comprised of a body, further comprised of at least one handle and a bottom surface having at least one rotating disc and at least one foot. The device may be comprised of a body with a top surface having at least one indicia, a bottom surface having at least one foot, and a handle further comprised of at least one grip. The body of the device is preferably made from a ceramic, cordierite, clay, metal, cast iron, stone, or a composite material that conducts heat, wherein the top surface of the body is comprised of at least one indicia that may only be visible when the internal temperature of the body exceeds a specific temperature.

The bottom surface of the body may further be comprised of at least one foot that is preferably manufactured from a material with low heat conducting properties and a high melting point. The foot is preferably flat such that it contacts any surface the device is placed on such that the bottom surface of the device does not contact the surface which the device is placed on. As a result, the surface cannot be burned, scorched, or warped by the hot bottom surface if the device is taken directly out of a pizza oven and placed onto a surface to cool or to serve pizza. In an alternative embodiment, the bottom surface has a single foot that attaches to the bottom surface via at least one rotating disc that allows the body to rotate while serving pizza while the foot remains stationary.

In one embodiment, the body is further comprised of at least one handle that can attach to the top surface, the bottom surface, or the side surface in a fixedly attached manner. The handle may also attach via at least one hinge that allows the handle to fold when not in use. The hinge may also be locked/unlocked using at least one button located on the handle. The handle is preferably made from a durable metal material and is further comprised of at least one grip that is preferably made from a rubber material with low heat conducting properties to allow a user to safely grab the handle when hot. In one embodiment, the grip may be textured to provide sufficient grip. In one embodiment, the handle is comprised of an opening that allows the handle (and therefore the device) to be hung or secured to another object, item, or location.

Accordingly, the pizza cooking stone device of the present invention is particularly advantageous as it provides an improved pizza stone that can be easily moved from a cooking oven to another location using the handle. Further, the feet ensure the device does not damage a surface when placed on said surface while hot, and the rotating disc improves the serving functionality of the device. In this manner, the pizza cooking stone device overcomes the limitations of existing pizza stones known in the art.

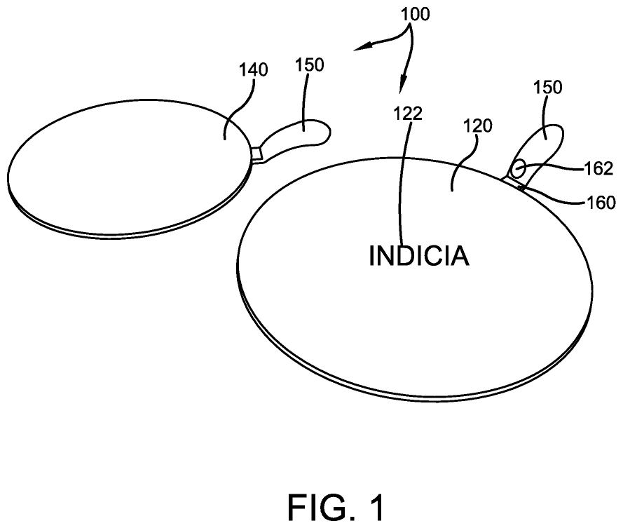

Referring initially to the drawings, FIG. 1 illustrates a perspective view of one potential embodiment of a pizza cooking stone device 100 of the present invention in accordance with the disclosed architecture. In the preferred embodiment, the device 100 is comprised of a body 110, further comprised of at least one handle 150 and a bottom surface 136, further comprised of at least one rotating disc 134 and at least one foot 132. The device 100 is primarily comprised of a body 110 with a top surface 120 having at least one indicia, a bottom surface 130 having at least one foot 132, and a handle 150 further comprised of at least one grip 152. The body 110 of the device 100 is preferably made from a ceramic, cordierite, clay, metal, cast iron, stone, or a composite material that conducts heat. In differing embodiments, the body 110 may be a plurality of thicknesses ranging from a one-quarter inch to two inches. The various thicknesses provide differing levels of heat conductivity to cook a pizza faster or slower and produce a more crispy/less crispy pizza. The body 110 may also be a plurality of shapes such as, but not limited to, circle, square, rectangle, triangle, polygonal, etc.

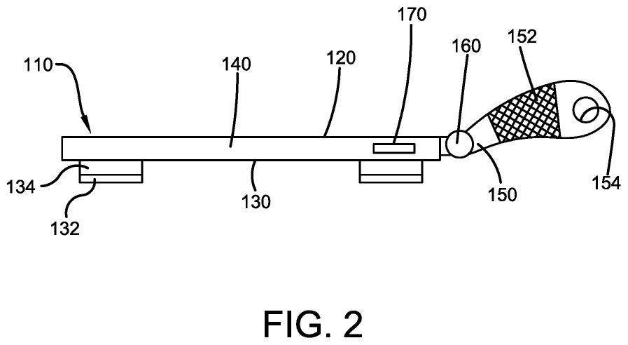

In one embodiment, the top surface 120 of the body 110 is comprised of at least one indicia 122 such as, but not limited to: patterns, logos, emblems, images, symbols, designs, letters, numbers, words, characters, animals, advertisements, brands, etc., as seen in FIG. 2. In one embodiment, the indicia 122 may only be visible when the temperature of the body 110 exceeds a specific temperature, such as, but not limited to, 50 degrees Fahrenheit. In this manner, the indicia 122 will be displayed as users take slices of pizza off the body 110. The top surface 120 is preferably non-stick. Further, the body 110 may be comprised of a thermochromic paint that can change from a first color to a second color when a threshold temperature is reached to alert a user that the device 100 is ready for cooking. Said temperature threshold may be, but is not limited to, 500 degrees Fahrenheit.

The bottom surface 130 of the body 110 may further be comprised of at least one foot 132. The foot 132 is preferably manufactured from a material with low heat conducting properties and a high melting point, such as, but not limited to, steel or bronze. The foot 132 is preferably flat. In this manner, the foot 132 contacts any surface the device 100 is placed on such that the bottom surface 130 of the device does not contact the surface which the device is placed on. In this manner, the surface cannot be burned, scorched, or warped by the hot bottom surface 130 if the device 100 is taken directly out of a pizza oven and placed onto a surface to cool or serve pizza. In one embodiment, the bottom surface 130 has a single foot 132 that attaches to the bottom surface 130 via at least one rotating disc 134. In this manner, the body 110 can rotate while serving pizza while the foot 132 remains stationary. The bottom surface 136 of the foot 132 may further have a non-skid texture such as, but not limited to, a plurality of ridges. In a differing embodiment, the rotating disc 134 may serve as a foot, wherein the device 100 is not comprised of a foot 132.

In one embodiment, the body 110 is further comprised of at least one handle 150. The handle 150 may be attached to the top surface 120, bottom surface 136, or side surface 140 in a fixedly attached manner. In another embodiment, the handle 150 is attached to the top surface 120, bottom surface 136, or side surface 140 via at least one hinge 160 that allows the handle 150 to fold when not in use. In a differing embodiment, the hinge 160 may be any hinge-type known in the art such as, but not limited to: an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc. The hinge 160 may also be locked/unlocked using at least one button 162 located on the handle 150.

The handle 150 is preferably made from a durable metal material such as, but not limited to, stainless steel or aluminium. In said embodiment, the handle 150 may further be comprised of at least one grip 152. The grip 152 is preferably made from a rubber material with low heat conducting properties to allow a user to safely grab the handle 150 when hot. In one embodiment, the grip 152 may be textured to provide sufficient grip. In another embodiment, the handle 150 may be entirely made out of a bronze or steel material that has low heat conducting properties. In one embodiment, the handle 150 is comprised of an opening 154. The opening allows the handle 150 (and therefore the device 100) to be hung or secured to another object, item, or location.

The body 110 may also be comprised of at least one thermometer 170. The thermometer displays the temperature of the body 110. In this manner, a user can closely monitor the temperature of the body 110 while cooking. Therefore, the pizza cooked using the device 100 will be cooked to the exact liking of the user. The thermometer 170 may be a digital thermometer, a mercury thermometer, or any thermometer type known in the art.

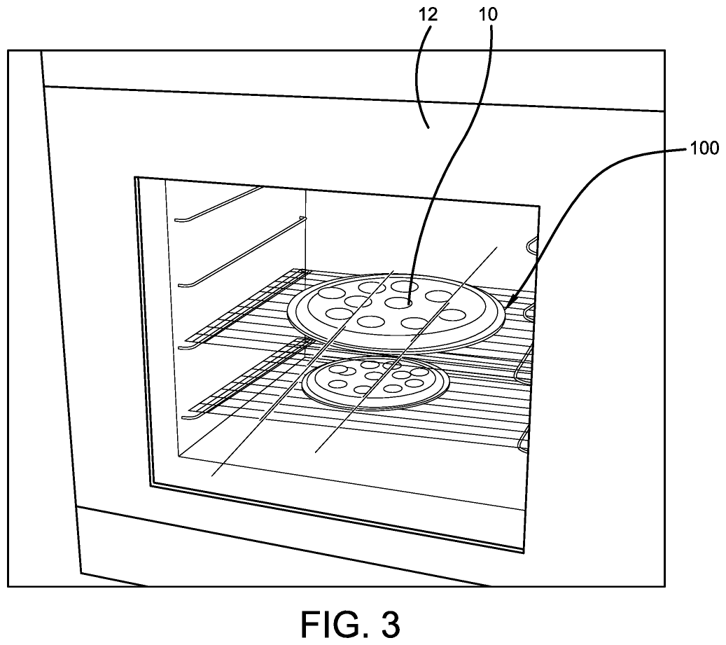

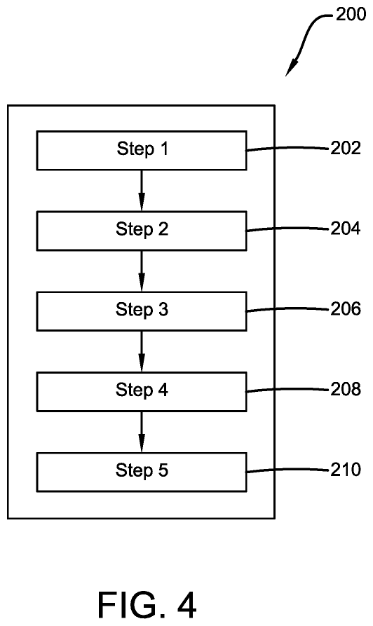

FIG. 4 illustrates a flowchart of one potential method 200 of using one potential embodiment of a pizza cooking stone device 100 of the present invention in accordance with the disclosed architecture. The device 100 is also comprised of a method 200 of using the device 100 to cook a pizza 10. First, a user uses the handle 150 to place the device 100 within an oven 12, as seen in FIG. 3 [Step 202]. Then, the user allows the device 100 to pre-heat to at least 500 degrees Fahrenheit [Step 204]. The temperature of the device 100 will be indicated by the thermometer 170 or from the body changing color from a first color to a second color. Then, the device 100 can be removed from the oven 12, a pizza can be placed on the top surface 120, and the device 100 and pizza 10 can be placed back into the oven to cook [Step 206]. After cooking is completed, the device 100 can be removed from the oven 12 using the handle 150 and placed on a surface to be served [Step 208]. While being served, the body 110 can rotate using the rotating disc 134 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pizza cooking stone device” and “device” are interchangeable and refer to the pizza cooking stone device 100 of the present invention.

Notwithstanding the foregoing, the pizza cooking stone device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the pizza cooking stone device 100 as shown in the FIGS. are for illustrative purposes only, and that many other sizes and shapes of the pizza cooking stone device 100 are well within the scope of the present disclosure. Although the dimensions of the pizza cooking stone device 100 are important design parameters for user convenience, the pizza cooking stone device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pizza cooking stone device comprising:
a body having a top surface, a bottom surface and a side surface;
a handle; and
a foot.

2. The pizza cooking stone device of claim 1, wherein the top surface is a non-stick surface.

3. The pizza cooking stone device of claim 1, wherein the body is comprised of a ceramic, a cordierite, a clay, a metal, a cast iron, a stone, or a composite material that conducts heat.

4. The pizza cooking stone device of claim 3, wherein the body has a thickness between a quarter-inch and two inches.

5. A pizza cooking stone device comprising:
a body having a top surface, a bottom surface and a side surface;
a handle;
a rotating disc; and
a foot.

6. The pizza cooking stone device of claim 5, wherein the body is further comprised of a thermometer.

7. The pizza cooking stone device of claim 6, wherein the thermometer is a digital thermometer.

8. The pizza cooking stone device of claim 5, wherein the body is comprised of a thermochromic paint that changes from a first color to a second color when heated to a threshold temperature.

9. The pizza cooking stone device of claim 8, wherein the threshold temperature is 500 degrees Fahrenheit.

10. The pizza cooking stone device of claim 5, wherein the rotating disc is attached to the bottom surface.

11. The pizza cooking stone device of claim 10, wherein the foot is attached to the rotating disc.

12. The pizza cooking stone device of claim 5, wherein the handle is further comprised of a grip.

13. The pizza cooking stone device of claim 12, wherein the grip has a texture.

14. The pizza cooking stone device of claim 5, wherein the handle attaches to the body via a hinge.

15. The pizza cooking stone device of claim 14, wherein the hinge can be locked or unlocked via a button on the handle.

16. The pizza cooking stone device of claim 13, wherein the grip is comprised of a rubber material.

17. The pizza cooking stone device of claim 5, wherein the top surface has an indicia that is only visible when the body exceeds a threshold temperature.

18. The pizza cooking stone device of claim 17, wherein the indicia is a pattern, a logo, an emblem, an image, a symbol, a design, a letter, a word, a character, an animal, an advertisement, or a brand.

19. The pizza cooking stone device of claim 17, wherein the threshold temperature is 50 degrees Fahrenheit.

20. A method of using a pizza cooking stone device, the method comprising the steps of:
using a handle of the pizza cooking stone device to place the pizza cooking stone device within an oven;
preheating the pizza stone cooking device to at least 500 degrees Fahrenheit;
removing the pizza cooking stone device from the oven;
placing a pizza on a top surface of the pizza stone cooking device;
placing the pizza stone cooking device and the pizza back into the oven;
cooking the pizza;
removing the pizza and the pizza stone cooking device from the oven; and
using the handle to place the pizza stone cooking device onto a surface to serve the pizza.
